(19) United States
(12) Patent Application Publication
(10) Pub. No.: US 2003/0158371 A1
(43) Pub. Date: Aug. 21, 2003

(54) Polycarbonate resin composition

(76) Inventors: Hiroshi Akamine, Chiba (JP); Akio Nodera, Chiba (JP); Katsushi Tsuchiya, Chiba (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/070,909

(22) PCT Filed: Jul. 10, 2001
(86) PCT No.: PCT/JP01/05975

(51) Int. Cl. C08G 64/00

(52) U.S. Cl. 528/196

(57) ABSTRACT

The invention relates to a polycarbonate resin composition favorable for parts of electric and electronic appliances. The composition comprises (a) from 65 to 95% by weight of a polycarbonate resin, (b) from 3 to 20% by weight of glass having a refractive index of from 1.570 to 1.600, and (c) from 2 to 15% by weight of a plasticizer, or is prepared by adding (a) from 0.01 to 5 parts by weight of metal-coated glass flakes, and (b) from 0.01 to 2 parts by weight of at least one stabilizer selected from phosphites, hindered phenolic compounds, epoxy compounds and benzotriazole compounds, to 100 parts by weight of a polycarbonate resin.

### TECHNICAL FIELD

The present invention (composed of first and second aspects) relates to a polycarbonate resin composition, more precisely to a polycarbonate resin composition favorable for parts of electric and electronic appliances.

### BACKGROUND ART

Generally having high mechanical strength and good heat resistance and transparency, polycarbonate resin is widely used as engineering plastics in various fields of, for example, electric and electronic appliances and automobiles. In addition, it has many applications for plastic glass and is widely used in various fields. Compared with conventional inorganic glass, however, plastic glass of polycarbonate resin has a problem in that its stiffness is low. To solve the problem, for example, Japanese Patent Laid-Open Nos. 60641/1983 and 251227/1987 disclose a glass fiber-reinforced polycarbonate resin composition that comprises a polycarbonate resin and glass fibers of which the refractive index is on the same level as that of the polycarbonate resin. However, the moldings obtained by injection-molding the glass fiber-reinforced polycarbonate resin composition show a phenomenon of glass fibers rising to their surfaces. The glass fibers rising to the surfaces of the moldings are problematic in that they reduce the surface smoothness of the moldings and that the parallel rays having passed through the moldings are scattered on the surfaces of the moldings and the visibility through the moldings (that is, the ability of the moldings to clearly show substances through them) is thereby lowered. Specifically, the external haze of the moldings is high, and therefore the overall transparency thereof is poor.

To solve the problems noted above, Japanese Patent Laid-Open No. 310956/1993 discloses a method of injection molding in which a resin film or sheet is fitted to the inner wall of the mold used. In the method, however, the operation for fitting the resin film or sheet to the inner wall of a mold is troublesome, and in addition, the method is substantially limited to only tabular moldings and is therefore not economical.

The first aspect of the invention has been made in consideration of the situation as above, and its object is to provide a glass-containing polycarbonate resin composition capable of being injection-molded into articles of high transparency and stiffness in a simple method.

On the other hand, it is known that a polycarbonate resin having a metallic appearance can be formed into articles of high quality that give a feeling of heaviness. For obtaining such metallic polycarbonate resin articles, known are a method of coating resin moldings with a metallic coat, and a method of mixing metal grains with a resin followed by molding the resin mixture. Requiring the complicated coating step, the former method is problematic in that it takes a lot of time and is expensive. As opposed to this, the latter method is favorable since it does not require the coating step. However, the problem with it is that the appearance and the quality of the articles obtained are not good, compared with those of the articles obtained in the former method. To solve the problem, proposed is a method of melt-mixing a resin with metal-coated glass flakes (for example, in Japanese Patent No. 2,651,058, Japanese Patent Laid-Open No. 258460/1995). In the method, however, the thermal and light stability of the resin used is not good, and the method is therefore problematic in that the resin products produced are degraded while they are used.

The second aspect of the invention has been made in consideration of the situation as above, and its object is to provide a polycarbonate resin composition of good thermal and light stability that can be formed into articles of good quality having a good metallic appearance.

### DISCLOSURE OF THE INVENTION

We, the present inventors have assiduously studied and, as a result, have found that a polycarbonate resin composition comprising specific glass and a plasticizer can effectively attain the object of the first aspect of the invention. On the basis of this finding, we have completed the first aspect of the invention.

Specifically, the first aspect of the invention is summarized as follows:

1. A polycarbonate resin composition comprising (a) from 65 to 95% by weight of a polycarbonate resin, (b) from 3 to 20% by weight of glass having a refractive index of from 1.570 to 1.600, and (c) from 2 to 15%by weight of a plasticizer. 2. The polycarbonate resin composition of above 1, which comprises (a) from 75 to 90% by weight of a polycarbonate resin, (b) from 5 to 15% by weight of glass having a refractive index of from 1.570 to 1.600, and (c) from 5 to 10% by weight of a plasticizer.

3. The polycarbonate resin composition of above 1 or 2, of which the haze of the 3 mm-thick injection-molded plate is at most 40.

4. The polycarbonate resin composition of any of above 1 to 3, wherein the glass of the component (b) is at least one type selected from glass fibers, glass flakes and glass powder.

5. The polycarbonate resin composition of any of above 1 to 4, wherein the plasticizer of the component (c) is selected from phosphorus compounds, higher fatty acid esters and polycaprolactones.

6. An injection-molded article of the polycarbonate resin composition of any of above 1 to 5.

7. The injection-molded article of above 6, which is for parts of electric and electronic appliances.

In addition, we have further found that a polycarbonate resin composition prepared by adding metal-coated glass flakes and a specific stabilizer to a polycarbonate resin satisfies the object of the second aspect of the invention. On the basis of this finding, we have completed the second aspect of the invention.

Specifically, the second aspect of the invention is summarized as follows:

1. A polycarbonate resin composition prepared by adding (a) from 0.01 to 5 parts by weight of metal-coated glass flakes, and (b) from 0.01 to 2 parts by weight of at least one stabilizer selected from phosphites, hindered phenolic compounds, epoxy compounds and benzotriazole compounds, to 100 parts by weight of a polycarbonate resin.

2. The polycarbonate resin composition of above 1, wherein the component (b) is a combination of a phosphite and a hindered phenolic compound.

3. The polycarbonate resin composition of above 1, wherein the component (b) is a combination of a phosphite and an epoxy compound.

4. The polycarbonate resin composition of above 1 wherein the component (b) is a combination of a phosphite, a hindered phenolic compound and a benzotriazole compound.

5. Parts of electric and electronic appliances formed by injection-molding the polycarbonate resin composition of any of above 1 to 4.

### BEST MODES OF CARRYING OUT THE INVENTION

Embodiments of the invention are described below.

I. First Aspect of the Invention:

The first aspect of the invention will be referred to simply as “the invention” in this section.

The polycarbonate resin of the component (a) that constitutes the polycarbonate resin composition of the invention is not specifically defined in point of its chemical structure and production method, for which, therefore, various types of polycarbonate resins are usable. For example, preferred are aromatic polycarbonate resins produced through reaction of a diphenol and a carbonate precursor.

Various types of diphenols are usable for the resins. For example, preferred are 2,2-bis(4-hydroxyphenyl)propane, bis(4-hydroxyphenyl)methane, 1,1-bis(4-hydroxyphenyl)ethane, 2,2-bis(4-hydroxy-3,5-dimethylphenyl)propane, 4,4′-dihydroxydiphenyl, bis(4-hydroxyphenyl)cyclohexane, bis(4-hydroxyphenyl) ether, bis(4-hydroxyphenyl) sulfide, bis(4-hydroxyphenyl) sulfone, bis(4-hydroxyphenyl) sulfoxide, bis (4-hydroxyphenyl) ketone, hydroquinone, resorcinol, and catechol. Of those diphenols, more preferred are bis(hydroxyphenyl)alkanes, especially 2,2-bis(4-hydroxyphenyl)propane [bisphenol A]. One or more of these diphenols may be used herein either singly or as combined.

The carbonate precursor includes, for example, carbonyl halides, carbonyl esters and haloformates. Concretely, they are phosgene, diphenol dihaloformates, diphenyl carbonate, dimethyl carbonate, and diethyl carbonate.

Regarding its chemical structure, the molecular chain of the polycarbonate resin has a linear, cyclic or branched structure. Of those, the polycarbonate resin having a branched structure is preferably prepared by the use of a branching agent such as 1,1,1-tris(4-hydroxyphenyl)ethane, α,α′,α″-tris(4-hydroxyphenyl)-1,3,5-triisopropylbenzene, phloroglucine, trimellitic acid, isatin-bis(o-cresol). For the polycarbonate resin, also usable are polyester-carbonate resins prepared by the use of ester precursors, for example, difunctional carboxylic acids such as terephthalic acid or their ester-forming derivatives. Further usable are mixtures of polycarbonate resins having different chemical structures.

The viscosity-average molecular weight of the polycarbonate resin for use herein generally falls between 10,000 and 50,000, but preferably between 13,000 and 35,000, more preferably between 15,000 and 25,000. To determine its viscosity-average molecular weight (Mv), the viscosity of the resin solution in methylene chloride at 20° C. is measured with an Ubbelohde's viscometer, from which is derived the limiting viscosity number [η] of the resin. Mv of the resin is calculated according to a formula, [η]=1.23×10⁻⁵ Mv^{0.83}. For controlling the molecular weight of the polycarbonate resin, for example, used is any of phenol, p-tert-butylphenol, p-dodecylphenol, p-tert-octylphenol, and p-cumylphenol.

For the polycarbonate resin, also usable are polycarbonate-polyorganosiloxane copolymers. The copolymers may be prepared, for example, by dissolving a polycarbonate oligomer and a polyorganosiloxane terminated with a reactive group in a solvent such as methylene chloride, adding thereto a diphenol in an aqueous sodium hydroxide solution, and polymerizing them in the presence of a catalyst such as triethylamine in a mode of interfacial polycondensation. For the polyorganosiloxane structure moiety of the copolymers, preferred are those having any of a polydimethylsiloxane structure, a polydiethylsiloxane structure, a polymethylphenylsiloxane structure and a polydiphenylsiloxane structure.

The polycarbonate-polyorganosiloxane copolymers preferably have a degree of polymerization of from 3 to 100 to form their polycarbonate moiety and a degree of polymerization of from 2 to 500 or so to form their polyorganosiloxane moiety. The polyorganosiloxane moiety content of the polycarbonate-polyorganosiloxane copolymer preferably falls between 0.5 and 10% by weight, more preferably between 3 and 6% by weight. The viscosity-average molecular weight of the polycarbonate-polyorganosiloxane copolymer preferably falls between 5,000 and 100,000, more preferably between 10,000 and 30,000.

The ratio of the component (a), polycarbonate resin falls between 65 and 95% by weight, preferably between 75 and 90% by weight, based on the total of the components (a), (b) and (c). If smaller than 65% by weight, it is unfavorable since the transparency and the impact strength of the resin composition lower; and if higher than 95% by weight, it is also unfavorable since the stiffness of the resin composition lowers.

Next described in order are the components (b) and (c) to be added to the polycarbonate resin.

(b) Glass:

Glass of any type and any morphology can be used for the component (b) to constitute the polycarbonate resin composition of the invention, so far as its refractive index (n_{D}) falls between 1.570 and 1.600. Glass having n_{D} of smaller than 1.570 or larger than 1.600 is unfavorable since it detracts from the transparency of the resin composition. For example, the composition of the glass of the type comprises from 55 to 60% by weight of SiO₂, from 10 to 12% by weight of Al₂O₃, from 20 to 25% by weight of CaO, from 0 to 5% by weight of MgO, from 0 to 5% by weight of TiO₂, from 0 to 5% by weight of ZnO, from 0.1 to 5% by weight of Na₂O, and from 0.1 to 5% by weight of K₂O. Regarding its morphology, the glass may be any of glass fibers, glass flakes and glass powder. One or more of these may be used either singly or as combined. Of those, glass fibers are widely used for reinforcing resins, and may be any of alkali glass, low-alkali glass or non-alkali glass. The fiber length falls between 0.05 and 8 mm, preferably between 2 and 6 mm; and the fiber diameter falls between 3 and 30 μm, preferably between 5 and 25 μm. The morphology of the glass fibers is not specifically defined, including, for example, rovings, milled fibers, and chopped strands. One or more different types of such glass fibers may be used herein either singly or as combined. For enhancing its affinity for resins, glass for use herein may be surface-treated with any of silane coupling agents such as aminosilanes, epoxysilanes, vinylsilanes and methacrylsilanes, or chromium complex compounds or boron compounds. One preferred example of glass for use herein is Asahi Fiber Glass' ECR glass.

The ratio of the component (b), glass falls between 3 and 20% by weight, preferably between 5 and 15% by weight, based on the total of the components (a), (b) and (c). If smaller than 3% by weight, it is unfavorable since the stiffness of the resin composition lowers; and if higher than 20% by weight, it is also unfavorable since the transparency and the impact strength of the resin composition lower.

(c) Plasticizer:

The component (c), plasticizer that constitutes the polycarbonate resin composition of the invention is not specifically defined and may be any one having the ability to lower the viscosity of the melt of the resin composition. Its preferred examples are phosphorus compounds, higher fatty acid esters, and polycaprolactones.

Concretely, for example, the phosphorus compounds are trimethyl phosphate, triethyl phosphate, tributyl phosphate, trioctyl phosphate, tributoxyethyl phosphate, triphenyl phosphate, tricresyl phosphate, cresyldiphenyl phosphate, octyldiphenyl phosphate, tri(2-ethylhexyl) phosphate, diisopropylphenyl phosphate, trixylenyl phosphate, tris(isopropylphenyl) phosphate, tributyl phosphate, bisphenol A bisphosphate, hydroquinone bisphosphate, resorcinol bisphosphate, resorcinol(diphenyl phosphate), trihydroxybenzene triphosphate, and cresyldiphenyl phosphate.

For the phosphorus compounds, herein usable are commercial products, such as Daihachi Chemical Industry's TPP [triphenyl phosphate], TXP [trixylenyl phosphate], PFR [resorcinol(diphenyl phosphate)], PX200 [1,3-phenylene-tetrakis(2,6-dimethylphenyl) phosphate], PX201 [1,4-phenylene-tetrakis(2,6-dimethylphenyl) phosphate], and PX202 [4,4′-phenylene-tetrakis (2,6-dimethylphenyl) phosphate].

The higher fatty acid esters may be partial or complete esters of mono or polyalcohols having from 1 to 10 carbon atoms with saturated fatty acids having from 10 to 30 carbon atoms. Concretely, for example, they are glycerin monostearate, glycerin distearate, glycerin tristearate, glycerin tetralaurate, sorbitan monostearate, pentaerythritol monostearate, pentaerythritol tetrastearate, pentaerythritol tetrapelargonate, propylene glycol monostearate, stearyl stearate, palmityl palmitate, butyl stearate, methyl laurate, isopropyl palmitate, and 2-ethylhexyl stearate.

The polycaprolactones are not specifically defined in point of their production method and terminal blocking structure. Preferably, however, they have a molecular weight of from 3,000 to 30,000 or so.

The ratio of the component (c), plasticizer falls between 2 and 15% by weight, preferably between 5 and 10% by weight, based on the total of the components (a), (b) and (c). If smaller than 2% by weight, it is unfavorable since the plasticizer is not effective for improving the transparency of the resin composition (that is, for reducing the external haze thereof); and if higher than 15% by weight, it is also unfavorable since the impact strength of the resin composition lowers.

Regarding the transparency of the polycarbonate resin composition that comprises the components (a), (b) and (c), it is desirable that the haze of the 3 mm-thick injection-molded plate of the composition is at most 40. If the haze is higher than 40, the transparency of the resin composition is low and the applications of the resin composition will be limited.

In addition to the constituent components thereof mentioned above, the polycarbonate resin composition of the invention may suitably contain additives that are generally used in ordinary thermoplastic resins and their compositions, depending on the necessary properties of its moldings. The additives are, for example, antioxidant, UV absorbent, light stabilizer, antistatic agent, antimicrobial agent, compatibilizer, colorant (dye, pigment), etc.

For producing the polycarbonate resin composition of the invention, the above-mentioned components (a), (b), (c) and other optional additives are blended and kneaded in a ratio that satisfies the necessary properties of the resin moldings. For blending and kneading them, usable are any ordinary mixers and kneaders. For example, they are pre-mixed in an ordinary mixer such as ribbon blender, drum tumbler or Henschel mixer, and are kneaded in a Banbury mixer, a single-screw extruder, a double-screw extruder, a multi-screw extruder or a cokneader. The temperature at which they are kneaded may fall generally between 240 and 300° C. For melt-kneading and molding the resin composition, preferably used is an extrusion molding machine, especially a vented extrusion molding machine. The constituent components except polycarbonate resin may be pre-mixed in melt with polycarbonate resin or any other thermoplastic resin to prepare a master batch, and it may be kneaded with polycarbonate resin.

After melt-kneaded in a melt-kneading and molding machine such as that mentioned above or after pelletized, the polycarbonate resin composition of the invention may be molded into various moldings, for example, through injection molding, injection compression molding, extrusion molding, blow molding, pressing or foaming. For molding the resin composition, especially preferred is a method that comprises melt-kneading the constituent components, pelletizing the resulting melt into molding pellets, and molding the pellets into articles through injection molding or injection compression molding. For injection-molding the pellets, especially preferred is a gas-assisted molding method, since the articles molded in the method have a good appearance with no sinking mark and their weight can be reduced.

The moldings of the polycarbonate resin composition thus obtained in the manner as herein are highly transparent and have a good surface appearance, and are therefore especially favorable to the field that requires the semi-transparency of the moldings, principally for parts of electric and electronic appliances.

The invention is described more concretely with reference to the following Examples and Comparative Examples, which, however, are not intended to restrict the scope of the invention.

[Examples I-1 to I-5, and Comparative Examples I-1 to I-4]

As in Table I-1, the components were mixed in the ratio indicated therein, then melt-kneaded in a 50-mmφ single-screw extruder (Nakatani's NVC50) at 280° C., and pelletized. Using a 45-ton injection-molding machine (Toshiba Kikai's IS45PV), the resulting pellets were injection-molded into test pieces having a size of 30×40 mm and a thickness of 3 mm, those for measuring the physical properties thereof, and those for evaluating the weldability thereof. The test pieces were tested according to the methods mentioned below, and their data are given in Table I-1. In the Table, “Example I-1”is referred to simply as “Example 1”, and the same shall apply to Comparative Examples.

The starting materials used, and the methods for evaluating the physical properties of the samples are described below.

[Starting Materials]

(a) Polycarbonate resin:

a-1: Polycarbonate resin [Idemitsu Petrochemical's Toughlon A1900], prepared from bisphenol A and having a melt flow rate (MFR) [measured according to JISK 7210, at a temperature of 300° C. under a load of 11.77 N] of 20 g/10 min and a viscosity-average molecular weight of 19,000.

a-2: Copolymer of polycarbonate (starting from bisphenol A) and PDMS (polydimethylsilane), having a PDMS content of 3% by weight and a viscosity-average molecular weight of 17,500.

(b) Glass material:

b-1: ECR glass (glass fibers with n_{D}=1.579, from Asahi Fiber Glass) having a fiber diameter of 13 μm and a fiber length of 3 mm.

b-2: TA-409C (glass fibers with n_{D}=1.545, from Asahi Fiber Glass) having a fiber diameter of 13 μm and a fiber length of 3 mm.

(c) Plasticizer:

c-1: PFR [resorcinol(diphenyl phosphate), by Daihachi Chemical Industry].

c-2: Triphenyl phosphate.

c-3: Pentaerythritol tetrastearate.

c-4: Polycaprolactone, Placcel H4 (by Daicel Chemical Industry).

[Method for Evaluating Physical Properties of Samples]

(1) Flexural modulus (MPa):

Measured according to JIS K 7203.

(2) IZOD impact strength (kJ/m²):

Measured according to JIS K 7110 (at 23° C., 3.2 mm).

(3) MFR (g/10 min):

Measured according to JIS K 7210 (at a temperature of 300° C. under a load of 11.77 N).

(4) YI:

Measured according to JIS K 7105.

(5) Haze:

Measured according to JIS K 7105 (3 mm).

(6) Product appearance:

◯: good.

Δ: some welds seen.

x: many welds and some flow marks seen.

TABLE I-1(1)

| | Exam- | Exam-2 | Exam- | Exam- | Exam- |
|---|---|---|---|---|---|
| | ple 1 | ple 2 | ple 3 | ple 4 | ple 5 |
| Blend Ratio wt. % | | | | | |
| (a) | | | | | |
| a-1 | 85.0 | — | — | — | — |
| a-2 | — | 85.0 | 85.0 | 90.0 | 86.5 |
| (b) | | | | | |
| b-1 | 9.5 | 9.5 | 9.5 | 5.0 | 4.5 |
| b-2 | — | — | — | — | — |
| (c) | | | | | |
| c-1 | 5.5 | 5.5 | — | — | — |
| c-2 | — | — | 5.5 | — | — |
| c-3 | — | — | — | 5.0 | — |
| c-4 | — | — | — | — | 9.0 |
| Evaluation of | | | | | |
| Physical Properties | | | | | |
| Flexural Modulus | 3,600 | 3,600 | 3,700 | 3,100 | 3,100 |
| IZOD Impact Strength | 6 | 15 | 11 | 12 | 10 |
| MFR | 12 | 12 | 14 | 10 | 15 |
| YI | 7 | 4 | 4 | 8 | 5 |
| Haze | 35 | 10 | 8 | 18 | 10 |
| Product Appearance | ∘ | ∘ | ∘ | Δ | ∘ |

TABLE I-1(2)

| | Comp. | Comp. | Comp. | Comp. |
|---|---|---|---|---|
| | Ex. 1 | Ex. 2 | Ex. 3 | Ex. 4 |
| Blend Ratio wt. % | | | | |
| (a) | | | | |
| a-1 | 90.0 | — | — | — |
| a-2 | — | 90.0 | 95.0 | 85.0 |
| (b) | | | | |
| b-1 | — | 10.0 | 5.0 | — |
| b-2 | 10.0 | — | — | 9.5 |
| (c) | | | | |
| c-1 | — | — | — | 5.5 |
| c-2 | — | — | — | — |
| c-3 | — | — | — | — |
| c-4 | — | — | — | — |
| Evaluation of | | | | |
| Physical Properties | | | | |
| Flexural Modulus | 3,400 | 3,400 | 2,900 | 3,600 |
| IZOD Impact Strength | 7 | 15 | 10 | 15 |
| MFR | 6 | 6 | 7 | 12 |
| YI | 25 | 15 | 10 | 12 |
| Haze | 70 | 50 | 42 | 45 |
| Product Appearance | x | x | x | ∘ |

II. Second Aspect of the Invention:

The second aspect of the invention will be referred to simply as “the invention” in this section.

The polycarbonate resin that constitutes the polycarbonate resin composition of the invention is not specifically defined in point of its chemical structure and production method, for which, therefore, various types of polycarbonate resins are usable. For the polycarbonate resin, referred to are those mentioned in the section of the first aspect of the invention. However, when the polycarbonate resin is a polycarbonate-polyorganosiloxane copolymer, the degree of polymerization to form the polycarbonate moiety preferably falls between 3 and 100 and that to form the polyorganosiloxane moiety preferably falls between 2 and 500 or so. The polyorganosiloxane moiety content of the polycarbonate-polyorganosiloxane copolymer preferably falls between 0.5 and 30% by weight, more preferably between 1 and 20% by weight. The viscosity-average molecular weight of the polycarbonate-polyorganosiloxane copolymer preferably falls between 5,000 and 100,000, more preferably between 10,000 and 30,000.

Next described in order are the components (a) and (b) to be added to the polycarbonate resin.

(a) Metal-coated glass flakes:

The glass flakes for use in the invention preferably have a mean particle size of from 0.01 to 3 mm and a mean thickness of from 1 to 30 μm. Glass flakes having a mean particle size of smaller than 0.01 mm will be ineffective for improving the metallic appearance and the quality of resin products containing them; and those having a mean particle size of larger than 3 mm will be readily broken while melted and mixed with resin. Glass flakes having a mean thickness of smaller than 1 μm will be readily broken while melted and mixed with resin; and those having a mean thickness of larger than 30 μm will be ineffective despite even though their predetermined amount is added to resin. The particle size referred to herein indicates the length of the longest side of each flake. The glass flakes may be any of alkali glass, low-alkali glass or non-alkali glass.

The metal to coat the glass flakes may be any and every one having a metallic gloss and capable of coating glass. For example, it includes gold, silver, nickel, and aluminium. The coating method is not specifically defined, and may be effected in any desired manner. For it, for example, preferred is electroless plating. The thickness of the metal coat generally falls between 0.00001 and 10 μm. The smooth surface of each glass flake and preferably even the edges thereof are uniformly coated with such a metal. The glass flakes thus uniformly coated with a metal can be directly used as they are, but may be further coated with a treating agent for preventing them from being oxidized.

In the resin composition of the invention, the content of the component (a) falls between 0.01 and 5 parts by weight, preferably between 0.1 and 2 parts by weight, relative to 100 parts by weight of the polycarbonate resin therein. If the content of the component is smaller than 0.01 parts by weight, the resin moldings could not have a good metallic appearance. If larger than 5 parts by weight, the physical properties of the resin moldings are not good.

(b) Stabilizer:

The stabilizer is at least one selected from phosphites, hindered phenolic compounds, epoxy compounds and benzotriazole compounds.

The phosphites are, for example, trialkyl phosphites such as trimethyl phosphite, triethyl phosphite, tributyl phosphite, trioctyl phosphite, trinonyl phosphite, tridecyl phosphite, trioctadecyl phosphite, tris(2-chloroethyl) phosphite, tris(2,3-dichloropropyl) phosphite; tricycloalkyl phosphites such as tricyclohexyl phosphite; triaryl phosphites such as tricresyl phosphite, tris(ethylphenyl) phosphite, tris(butylphenyl) phosphite, tris(nonylphenyl) phosphite, tris(hydroxyphenyl) phosphite, tris(2,4-di-t-butylphenyl) phosphite; dialkylmonoaryl phosphites such as bis(2,6-di-t-butyl-4-methylphenyl)pentaerythritol phosphite. Of those, preferred are triaryl phosphites and dialkylmonoaryl phosphites.

The hindered phenolic compounds are, for example, octadecyl-3-(3,5-di-t-butyl-4-hydroxyphenyl)propionate, triethylene glycol-bis[3-(3-t-butyl-5-methyl-4-hydroxyphenyl)propionate], 1,6-hexanediol-bis[3-(3,5-di-t-butyl-4-hydroxyphenyl)propionate], pentaerythrityl tetrakis[3-(3,5-di-t-butyl-4-hydroxyphenyl)propionate], N,N′-hexamethylenebis[(3,5-di-t-butyl-4-hydroxy)-hydrocinnamide], 2,2-thio-diethylenebis[3-(3,5-di-t-butyl-4-hydroxyphenyl)propionate], 2,4-bis(n-octylthio)-6-(4-hydroxy-3,5-di-t-butylanilino)-1,3,5-triazine, 1,3,5-trimethyl-2,4,6-tris(3,5-di-t-butyl-4-hydroxybenzyl)benzene, tris(3,5-di-t-butyl-4-hydroxybenzyl) isocyanurate, and calcium bis (ethyl 3, 5-di-t-butyl-4-hydroxybenzylphosphonate). Of those, preferred is octadecyl 3-(3,5-di-t-butyl-4-hydroxyphenyl)propionate.

The epoxy compounds have at least one epoxy group in the molecule, and preferably, they do not have a halogen. Concretely, for example, they are epoxidated soybean oil, epoxidated linseed oil, epoxybutyl stearate, epoxyoctyl stearate, phenyl glycidyl ether, allyl glycidyl ether, p-butylphenyl, glycidyl ether, styrene oxide, neohexene oxide, diglycidyl adipate, diglycidyl sebacate, diglycidyl phthalate, bisepoxydicyclopentadienyl ether, ethylene glycol diglycidyl ether, propylene glycol diglycidyl ether, polyethylene glycol diglycidyl ether, butadiene diepoxide, tetraphenylethylene epoxide, epoxidated polybutadiene, epoxidated styrene-butadiene copolymer, bisphenol A epoxide, bisphenol S epoxide, phenol-novolak epoxide, resorcinol epoxide, 3,4-epoxycyclohexamethyl-3,4-epoxycyclohexylcarboxylate, and 3,4-epoxycyclohexyl glycidyl ether. Of those, preferred is 3,4-epoxycyclohexamethyl 3,4-epoxycyclohexylcarboxylate.

The benzotriazole compounds are, concretely, for example, 2-(2′-hydroxy-5′-t-octylphenyl)benzotriazole, 2-(2′-hydroxy-3′,5′-di-t-amylphenyl)benzotriazole, 2-(2′-hydroxy-5′-t-butylphenyl)benzotriazole, 2-(2′-hydroxy-3′,5′-di-t-butylphenyl)benzotriazole, 2-[2′-hydroxy-3′,5′-bis(α,α-dimethylbenzyl)phenyl]-2H-benzotriazole, and 2,2′-methylene-bis[4-methyl-6-(benzotriazol-2-yl)phenol].

For the component (b), at least one is selected from the compounds mentioned above. Especially preferred for it is a combination of a phosphite and a hindered phenolic compound; a combination of a phosphite and an epoxy compound; or a combination of a phosphite, a hindered phenolic compound and a benzotriazole compound.

In the resin composition of the invention, the content of the component (b) falls between 0.01 and 2 parts by weight, preferably between 0.02 and 0.5 parts by weight, relative to 100 parts by weight of the polycarbonate resin therein. If the content thereof is smaller than 0.01 parts by weight, the stabilizer is ineffective; but even if larger than 2 parts by weight, the effect of the stabilizer does not augment any more.

In addition to the constituent components thereof mentioned above, the polycarbonate resin composition of the invention may suitably contain additives that are generally used in ordinary thermoplastic resins and their compositions, depending on the necessary properties of its moldings. The additives are, for example, antistatic agent, plasticizer, antimicrobial agent, compatibilizer, colorant (dye, pigment), etc.

For the method of producing the polycarbonate resin composition of the invention, referred to is that mentioned hereinabove in the section of the first aspect of the invention. For the method of molding the resin composition into various moldings, also referred to is that mentioned in the section of the first aspect of the invention.

The moldings of the polycarbonate resin composition of the invention are favorable for parts of electric and electronic appliances and automobile parts.

The invention is described more concretely with reference to the following Examples and Comparative Examples, which, however, are not intended to restrict the scope of the invention.

[Examples II-1 to II-6, and Comparative Examples II-1 to II-4]

As in Table II-1, the components were mixed in the ratio indicated therein (in terms of parts by weight relative to 100 parts by weight of the polycarbonate resin), then melt-kneaded in a 50-mmφ single-screw extruder (Nakatani's NVC50) at 280° C., and pelletized. Using a 45-ton injection-molding machine (Toshiba Kikai's IS45PV), the resulting pellets were injection-molded into test pieces having a size of 30×40 mm and a thickness of 3.2 mm. The test pieces were tested for their physical properties according to the methods mentioned below, and their data are given in Table II-1. In the Table, “Example II-1” is referred to simply as “Example 1”, and the same shall apply to Comparative Examples.

The starting materials used, and the methods for evaluating the physical properties of the samples are described below.

[Starting Materials]

The polycarbonate resin used herein is Idemitsu Petrochemical's Toughlon A2200, prepared from bisphenol A and having a melt flow rate (MFR) [measured according to JIS K 7210, at a temperature of 300° C. under a load of 11.77 N] of 10 g/10 min and a viscosity-average molecular weight of 21,600.

(a) Metal-coated glass flakes:

a-l: Nickel-coated glass flakes [Nippon Sheet Glass' Metashine Nickel RCFSX-5230NS (9402), prepared by plating glass flakes having a mean particle size of 0.23 mm and a mean thickness of 5 μm with 0.15 μm-thick nickel in a mode of electroless plating].

a-2 (for comparison): Aluminium powder (Toyo Aluminium's P0100).

(b) Stabilizer:

b-1: Bis(2,6-di-t-butyl-4-methylphenyl)pentaerythritol phosphite [Adekastab PEP-36, by Asahi Denka).

b-2: Tris(2,4-di-t-butylphenyl) phosphite [Irgafos 168, by Ciba Speciality Chemicals].

b-3: Octadecyl-3-(3,5-di-t-butyl-4-hydroxyphenyl)propionate [Irganox 1076, by Ciba Speciality Chemicals].

b-4: 3,4-epoxycyclohexamethyl-3,4-epoxycyclohexylcarboxylate.

b-5: 2-(2′-hydroxy-5′-t-octylphenyl)benzotriazole.

[Method for Evaluating Physical Properties of Samples]

(1) Reduction in Molecular Weight of Moldings:

The reduction in the viscosity-average molecular weight of the moldings from that of the resin pellets is measured (ΔMv). (Mv is measured according to the method mentioned hereinabove.)

(2) IZOD Impact Strength (kJ/m²):

Measured according to JIS K 7110 (at 23° C., 3.2 mm).

(3) Oven Aging:

After heated at 140° C. for 500 hours, YI of the moldings is measured according to JIS K 7103, and the color difference ΔE is derived from it.

(4) Steam Resistance:

After heated in steam at 120° C. for 100 hours, Mv of the moldings is measured, and ΔMv is derived from it.

(5) Weather Resistance:

Using a xenon weather-meter, the moldings are exposed to light at 63° C. in no rain. YI of the moldings is measured before the test and after exposed to light for 300 hours, according to JIS K 7103, and the color difference ΔE is derived from it.

(6) Product Appearance:

00: good.

0: good, but some welds seen.

x: many welds and flow marks seen.

TABLE II-1(1)

| | Example 1 | Example 2 | Example 3 | Example 4 |
|---|---|---|---|---|
| Blend Ratio wt. pts. | | | | |
| (a) | | | | |
| a-1 | 1.0 | 1.0 | 1.0 | 1.0 |
| a-2 | — | — | — | — |
| (b) | | | | |
| b-1 | 0.075 | — | 0.075 | 0.075 |
| b-2 | — | 0.075 | — | — |
| b-3 | — | — | 0.025 | 0.025 |
| b-4 | — | — | — | — |
| b-5 | — | — | 0.3 | — |
| Reduction in Molecular | 1,000 | 1,200 | 800 | 600 |
| Weight of Moldings | | | | |
| IZOD Impact Strength | 60 | 60 | 70 | 70 |
| Oven Aging | 8 | 8 | 4 | 4 |
| Steam Resistance | 2,000 | 2,600 | 1,800 | 1,800 |
| Weather Resistance | 3.4 | 4.0 | 1.5 | 3.2 |
| Product Appearance | ∘ | ∘ | ∘∘ | ∘∘ |

TABLE II-1(2)

| | | | Comp. | Comp. |
|---|---|---|---|---|
| | Example 5 | Example 6 | Ex. 1 | Ex. 2 |
| Blend Ratio wt. pts. | | | | |
| (a) | | | | |
| a-1 | 1.0 | 1.0 | 1.0 | 6.0 |
| a-2 | — | — | — | — |
| (b) | | | | |
| b-1 | 0.05 | 0.075 | — | 0.075 |
| b-2 | — | — | — | — |
| b-3 | 0.025 | — | — | 0.025 |
| b-4 | — | 0.1 | — | — |
| b-5 | — | — | — | — |
| Reduction in Molecular | 800 | 500 | 3,000 | 1,500 |
| Weight of Moldings | | | | |
| IZOD Impact Strength | 70 | 75 | 15 | 10 |
| Oven Aging | 4 | 4 | 18 | 12 |
| Steam Resistance | 1,800 | 1,600 | 8,000 | 4,000 |
| Weather Resistance | 3.2 | 3.0 | 6.0 | 4.4 |
| Product Appearance | ∘∘ | ∘∘ | ∘∘ | x |

TABLE II-1(3)

| | Comp. Ex. 3 | Comp. Ex. 4 |
|---|---|---|
| Blend Ratio wt. pts. | | |
| (a) | | |
| a-1 | — | — |
| a-2 | 1.0 | 1.0 |
| (b) | | |
| b-1 | 0.075 | — |
| b-2 | — | 0.075 |
| b-3 | 0.025 | — |
| b-4 | — | — |
| b-5 | — | — |
| Reduction in Molecular Weight of Moldings | 2,000 | 2,300 |
| IZOD Impact Strength | 18 | 12 |
| Oven Aging | 23 | 25 |
| Steam Resistance | 6,000 | 6,000 |
| Weather Resistance | 7.0 | 8.0 |
| Product Appearance | x | x |

### INDUSTRIAL APPLICABILITY

The first aspect of the invention provides a glass-containing polycarbonate resin composition capable of being injection-molded into articles of good transparency, stiffness and molding stability (discoloration resistance) in a simple method. The second aspect of the invention provides a polycarbonate resin composition of good thermal stability, which can be formed into articles having a good metallic appearance.

1. A polycarbonate resin composition comprising (a) from 65 to 95% by weight of a polycarbonate resin, (b) from 3 to 20% by weight of glass having a refractive index of from 1.570 to 1.600, and (c) from 2 to 15%by weight of a plasticizer.

2. The polycarbonate resin composition as claimed in claim 1, which comprises (a) from 75 to 90% by weight of a polycarbonate resin, (b) from 5 to 15% by weight of glass having a refractive index of from 1.570 to 1.600, and (c) from 5 to 10% by weight of a plasticizer.

3. The polycarbonate resin composition as claimed in claim 1 or 2, of which the haze of the 3 mm-thick injection-molded plate is at most 40.

4. The polycarbonate resin composition of as claimed in any of claims 1 to 3, wherein the glass of the component (b) is at least one type selected from glass fibers, glass flakes and glass powder.

5. The polycarbonate resin composition as claimed in any of claims 1 to 4, wherein the plasticizer of the component (c) is selected from phosphorus compounds, higher fatty acid esters and polycaprolactones.

6. An injection-molded article of the polycarbonate resin composition of any of claims 1 to 5.

7. The injection-molded article as claimed in claim 6, which is for parts of electric and electronic appliances.

8. A polycarbonate resin composition prepared by adding (a) from 0.01 to 5 parts by weight of metal-coated glass flakes, and (b) from 0.01 to 2 parts by weight of at least one stabilizer selected from phosphites, hindered phenolic compounds, epoxy compounds and benzotriazole compounds, to 100 parts by weight of a polycarbonate resin.

9. The polycarbonate resin composition as claimed in claim 8, wherein the component (b) is a combination of a phosphite and a hindered phenolic compound.

10. The polycarbonate resin composition as claimed in claim 8, wherein the component (b) is a combination of a phosphite and an epoxy compound.

11. The polycarbonate resin composition as claimed in claim 8, wherein the component (b) is a combination of a phosphite, a hindered phenolic compound and a benzotriazole compound.

12. Parts of electric and electronic appliances formed by injection-molding the polycarbonate resin composition of any of claims 8 to 11.
